(19) United States
(12) Patent Application Publication
(10) Pub. No.: US 2024/0420938 A1
(43) Pub. Date: Dec. 19, 2024

(54) ION DETECTORS

(71) Applicant: Micromass UK Limited, Wilmslow (GB)

(72) Inventors: David Gordon, Middlewich (GB); Richard Moulds, Stockport (GB)

(73) Assignee: Micromass UK Limited, Wilmslow (GB)

(21) Appl. No.: 18/698,443

(22) PCT Filed: Oct. 3, 2022
(86) PCT No.: PCT/GB2022/052503

§ 371 Date: Apr. 4, 2024

(30) Foreign Application Priority Data
Oct. 4, 2021 (GB) 2114199.9

(51) Int. Cl. H01J 49/02; H01J 49/00

(52) U.S. Cl. CPC H01J 49/025; H01J 49/0031

(57) ABSTRACT

An ion detector for a mass and/or ion mobility spectrometer is disclosed. The ion detector comprises a dynode arranged and configured such that primary ions to be detected by the ion detector impact upon the dynode and generate first electrons and secondary positive ions, an electron detector arranged and configured to attract and detect said first electrons, and an apertured electrode. The apertured electrode comprises a plurality of apertures and is arranged and configured such that at least some of said secondary positive ions pass through the apertures of the electrode.

### CROSS-REFERENCES TO RELATED APPLICATIONS

This application claims priority from and the benefit of United Kingdom patent application No. 2114199.9 filed on 4 Oct. 2021. The entire contents of this application is incorporated herein by reference.

### FIELD

The present disclosure relates to ion detectors for mass and/or ion mobility spectrometers.

### BACKGROUND

Ion detectors for mass spectrometers are known that detect ions that enter the detector (primary ions) using a dynode, i.e. using an electrode that emits electrons when primary ions impact upon it. Ions incident on the dynode may then be detected based on the detection of the resulting electrons generated when the ions collide with the dynode.

In addition to the electrons generated when primary ions impact the dynode, secondary positive ions are also generated, via fragmentation of the primary ions as they collide with the dynode. It is possible to detect the primary ions that are incident on the dynode by detecting the resulting secondary ions that are generated, rather than detecting the electrons that are generated. For example, the secondary positive ions may be detected using a scintillator and/or further dynodes that the secondary positive ions impact upon. However, such detection performs poorly at low ion masses, as there is relatively inefficient generation of secondary positive ions from collisions of these low mass ions at the dynode. As such, it may be preferred to detect primary ions incident on the dynode by detecting the electrons that are generated.

Nevertheless, when it is intended to detect primary ions by detecting a signal resulting from the electrons that are generated, the secondary positive ions may still cause a contribution to the detected signal. This is because the secondary positive ions may generate additional electrons as a result of collisions between the secondary positive ions and parts of the detector. These additional electrons may then also be detected. A problem with this is that the additional electrons generated from the secondary positive ions can cause a relatively large variation in the signals that result when individual ions impact the dynode. In particular, the distribution of the signals that result from ions that impact the dynode (i.e. the number of ion detection events as a function of the signal intensity, which is also known as the pulse height distribution) may have a bimodal distribution with one mode that results from electrons generated directly from the primary ions colliding with the dynode, and a second mode that results from electrons generated from collisions of the secondary positive ions with a surface in the detector other than the dynode. The relative contributions of the two modes to the detected signal will depend on the efficiency with which the secondary positive ions are generated and this will depend on, for example, the mass of the primary ions to be detected. The presence of the two modes may broaden and/or reduce the signal to noise ratio of the pulse height distribution. When the pulse height distribution is broad, the number of ions cannot be accurately quantified from the detected signal, particularly when trying to quantify relatively few ions. A low signal to noise ratio may also mean that a proportion of the ions entering the detector fail to be detected, particularly when the rate of ions entering the detector is low. For example, ions may be detected only when the detected signal is above a particular threshold. However, when there is a large variation in the signal resulting from ions impacting upon the dynode, a proportion of the signal resulting from the ions impacting upon the dynode may fall below the threshold.

### SUMMARY

The present disclosure provides an ion detector for a mass and/or ion mobility spectrometer, comprising: a dynode arranged and configured such that primary ions to be detected by the ion detector impact upon the dynode and generate first electrons and secondary positive ions; an electron detector arranged and configured to attract and detect said first electrons; and an apertured electrode, comprising a plurality of apertures, that is arranged and configured such that at least some of said secondary positive ions pass through the apertures of the electrode.

When the primary ions impact upon the dynode, said first electrons are emitted from the dynode and secondary positive ions are generated, e.g. via fragmentation of the primary ions. Additional electrons (second electrons) may then be generated by the secondary positive ions colliding with a surface of the ion detector other than the dynode. It is undesired for these second electrons to be detected, for the reasons discussed herein. By providing an apertured electrode in accordance with the present disclosure, at least some of the secondary positive ions pass through its apertures without striking the apertured electrode. As such, these secondary positive ions may be removed from the region of the ion detector where it would be problematic if they impacted upon a surface and generated electrons. The first electrons are attracted to the electron detector without passing through the apertures of the apertured electrode (i.e. by bypassing the apertured electrode). The apertured electrode may thereby filter the secondary positive ions from the first electrons.

The ion detector may comprise a housing that houses the dynode and the housing may have an opening for enabling the primary ions to enter the housing and impact upon the dynode.

The first electrons may be detected by the electron detector in any suitable manner. For example, the electron detector may comprise a scintillator (e.g. phosphorescent screen) and a photomultiplier, and/or the electron detector may comprise an electron multiplier. The electron detector may comprise a circuit for measuring an electronic signal amplified by a photomultiplier or electron multiplier.

The apertured electrode may be arranged and configured within the ion detector such that at least some of said secondary positive ions pass through said apertures and then strike a surface of the ion detector that is on the opposite side of the apertured electrode to said dynode.

The ion detector may be configured such that when said secondary positive ions strike said surface they generate second electrons, and the apertured electrode may be arranged within the ion detector and configured such that said second electrons are unable to reach the electron detector.

The ion detector may be configured to provide an electric field between the dynode and the electron detector that attracts the first electrons from the dynode to the electron detector, and the apertured electrode may be configured to prevent the electric field between the dynode and the electron detector from attracting the second electrons towards the electron detector.

The ion detector may comprise any suitable voltage generator(s) or supplies for supplying the electric fields and potentials discussed herein.

The ion detector may be configured to provide the electric field between the dynode and the apertured electrode by the ion detector applying a more negative electric potential to the apertured electrode than is applied to the dynode.

The ion detector may be arranged so that the electron detector is on the same side of the apertured electrode as the dynode, and the ion detector may be configured so that the electric field between the dynode and the apertured electrode deflects the secondary positive ions such that the secondary positive ions pass through the apertures to the other side of the apertured electrode.

The ion detector may be configured to maintain the apertured electrode at ground potential or at a negative potential.

Grounding the apertured electrode enables second electrons on the other side of the apertured electrode to said dynode to be shielded from the electric field between the dynode and the electron detector, so as to prevent the second electrons being attracted onto the electron detector. The apertured electrode thereby being configured such that said second electrons are unable to reach the electron detector. However, it is contemplated that rather than the apertured electrode being grounded it may be at a negative potential. This will help to repel any second electrons that are generated and prevent them from passing through the apertured electrode and towards the electron detector.

The ion detector may be configured to provide a potential difference between the dynode and the apertured electrode that is greater than or equal to 1 kV, greater than or equal to 3 kV, or greater than or equal to 5 kV. Providing a relatively high potential difference between the dynode and the apertured electrode can reduce the likelihood of secondary positive ions colliding with parts of the ion detector before reaching the apertured electrode. Also, this provides the secondary positive ions with a relatively high speed when they reach the apertured electrode, so as to increase the likelihood that they pass directly through the apertures rather than being deflected onto the apertured electrode.

A positive electrical potential applied to the dynode may be greater than 3 kV, such as for example between 5 and 10 kV. The electric potential of the dynode can be used to attract negative primary ions to be detected as well as repelling the secondary positive ions that are generated.

The ion detector may be configured to apply a higher electric potential to a collision surface of the electron detector, such as a scintillator (e.g. phosphorescent screen) or electron multiplier dynode, than the electric potential applied to the dynode. This can allow the first electrons to be attracted to, and detected by, the electron detector. For example, the electric potential applied to the collision surface of the electron detector may be equal to or greater than 10 kV.

The magnitude of an electric potential applied to the apertured electrode may be relatively small compared to the magnitude of the electric potential applied to the dynode. If a negative potential is applied to the apertured electrode, having the magnitude of the electric potential applied to the apertured electrode be relatively small can reduce the likelihood that secondary positive ions accelerated towards the apertured electrode will collide with the apertured electrode and/or will be deflected back into or through the apertures of the electrode after passing through the apertures. Therefore, a negative potential that is equal to or more positive than-1 kV may be applied to the apertured electrode, such as equal to or more positive than-500 V, equal to or more positive than-300 V, or equal to or more positive than-100 V.

At least some of the apertures in the apertured electrode may each have a shape selected from the following shapes: a square; an elongated rectangle, a circle, an oval, a triangle, a polygon, a hexagon, or a slot.

For example, the apertured electrode may have a plurality of elongated slots arranged in parallel and adjacent with each other. Such elongated slots may be formed, for example, between parallel wires.

The apertures in the apertured electrode may be square and a ratio of the average width of the apertures to the average distance separating adjacent ones of the apertures may be between 5 and 15, between 6 and 14, between 7 and 13, between 8 and 12, or between 9 and 11.

Having the width of the apertures approximately 10 times larger than the distance separating the apertures can provide relatively large apertures for the secondary ions to pass through while still allowing a substantially uniform and/or continuous electric potential to be maintained across the face of the electrode.

The combined area of the apertures of the apertured electrode divided by the total area of the apertured electrode may be: ≥0.5; ≥0.6; ≥0.7; ≥0.8; ≥0.9; or ≥0.95.

The combined area of the apertures of the apertured electrode divided by the total area of the apertured electrode may also be up to 0.99.

The apertured electrode may be a sheet, such as a planar sheet. The areas referred to are the areas in the plane of the sheet. Therefore, the total area of the apertured electrode is the area of one of the major surfaces of the sheet.

Providing an apertured electrode with such a void fraction allows a substantially uniform and/or continuous electric potential to be maintained across the apertured electrode while still providing a relatively large void in the apertured electrode so that secondary positive ions may pass through the apertures of the electrode. In comparison, having, for example, a single large aperture in a wall of the ion detector in place of the apertured electrode may prevent a suitable electric field being provided that can reliably deflect ions in the required manner.

The plurality of apertures may comprise at least 10 apertures, optionally at least 50 apertures.

The average width of the apertures may be between 1 and 10 mm, optionally between 2 and 5 mm.

The plurality of apertures may be arranged in a two-dimensional array, optionally wherein the electrode is provided as a grid or a mesh.

The ion detector may be arranged and configured to provide an electric field between the apertured electrode and the dynode to deflect primary ions away from the apertured electrode and towards the dynode such that the primary ions impact upon the dynode.

In this case, the ion detector may be arranged and configured for the electric field between the dynode and the apertured electrode to be used to both deflect secondary positive ions away from the dynode and to deflect negative primary ions towards the dynode. The dynode and apertured electrode may be on either side of an axis through an opening in a housing of the ion detector that houses the dynode, wherein the opening is to enable negative primary ions to enter the housing and impact upon the dynode.

The apertured electrode may form part of a wall of a chamber of the ion detector containing the dynode.

The present disclosure also provides a mass and/or ion mobility spectrometer comprising the ion detector disclosed herein.

The present disclosure also provides a method of detecting ions for mass and/or ion mobility spectrometry, the method comprising: providing an ion detector comprising a dynode, an electron detector and an apertured electrode comprising a plurality of apertures; impacting primary ions to be detected upon the dynode to generate first electrons and secondary positive ions; attracting the first electrons to the electron detector and detecting the first electrons using the electron detector; and passing at least some of said secondary positive ions through the apertures of the apertured electrode.

The method may comprise providing an ion detector having any of the features disclosed herein.

### BRIEF DESCRIPTION OF THE DRAWINGS

Various embodiments will now be described, by way of example only, and with reference to the accompanying drawings in which:

FIG. 1 shows a schematic of an example of an ion detector;

FIG. 2 shows a schematic of an alternative example of an ion detector;

FIG. 3 shows pulse height distributions for the detection of three different ions using the ion detector of FIG. 1;

FIG. 4 shows a schematic of an ion detector that is in accordance with embodiments of the present disclosure;

FIG. 5 shows a schematic of an alternative ion detector that is in accordance with embodiments of the present disclosure; and

FIG. 6 shows a schematic of an apertured electrode that is in accordance with embodiments of the present disclosure.

### DETAILED DESCRIPTION

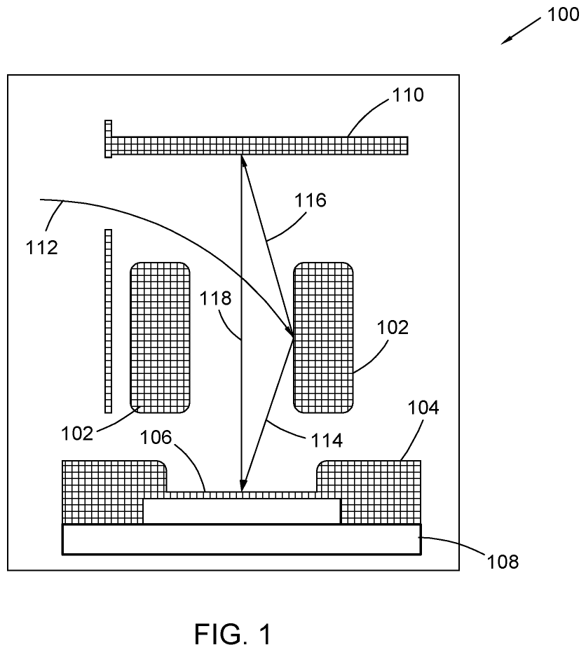

FIG. 1 shows a schematic of an example of an ion detector 100 for the detection of negative primary ions 112, which does not have the features of the present invention. The ion detector 100 comprises an annular dynode 102 that emits electrons when negative primary ions 112 impact upon the dynode 102. The ion detector 100 also comprises an electron detector 104 that can detect electrons emitted from the dynode 102 to thereby allow the detection of a primary ion by the ion detector 100. The electron detector 104 comprises a phosphorescent screen 106 and a photomultiplier 108.

In the ion detector 100, an electric field is defined by the dynode 102 and a plate electrode 110. For example, a positive potential of, say, 5 kV may be applied to the dynode 102 so as to attract the primary ions 112 with sufficient energy such that when they impact the dynode 102 they generate sufficient electrons. The plate electrode 110 may be grounded. The electric field defined by the dynode 102 and the grounded plate 110 is configured so that when negative primary ions 112 enter the ion detector 100, the field will deflect the ions 112 so that they impact upon the dynode 102. Upon impact of the negative primary ions 112 on the dynode 102, both electrons 114 and secondary positive ions 116 may be generated. More specifically, electrons 114 may be emitted by the dynode 102 and secondary positive ions 116 may be generated via fragmentation of the negative primary ions 112.

A positive potential applied at the phosphorescent screen 106 is greater than the potential applied to the dynode 102 so that the electrons 114 emitted from the dynode 102 are attracted towards, and impact upon, the phosphorescent screen 106. For example, the phosphorescent screen 106 may have a potential of, say, 10 kV. When electrons 114 impact upon the phosphorescent screen 106, photons (not shown) are emitted by the phosphorescent screen 106 and are detected using the photomultiplier 108 in the known manner. This thereby allows the detection of negative primary ions 112 that enter the ion detector 100.

The secondary positive ions 116 that are generated when a negative primary ion impacts upon the dynode 102 are repelled by both the dynode 102 and the phosphorescent screen 106 and are deflected by the electric field defined between the grounded plate 110 and the dynode 102. This causes the secondary positive ions 116 to travel towards, and impact upon, the grounded plate 110. Upon impact of the secondary positive ions 116 on the grounded plate 110, electrons 118 may be generated at the grounded plate 110. The potential difference between the grounded plate 110 and the phosphorescent screen 106 causes electrons 118 to be attracted through the annular dynode 102 and onto the phosphorescent screen 106. This results in the generation of photons that are detected by the photomultiplier 108. Furthermore, as the potential difference between the grounded plate 110 and the phosphorescent screen 106 is greater than the potential difference between the dynode 102 and the phosphorescent screen 106, electrons 118 generated at the grounded plate 110 from secondary positive ions 116 are accelerated onto the phosphorescent screen 106 with a higher energy than electrons 114 emitted from the dynode 102. Therefore, not only does the generation of secondary ions 116 cause electrons 118 to be generated that contribute to the ion signal detected by photomultiplier 108, which may be problematic, but also these electrons 118 may result in a higher intensity signal being generated at the phosphorescent screen 106 than the electrons 114 from the dynode.

The number of electrons 114 and secondary positive ions 116 generated as a result of a primary ion 112 impacting upon the dynode 102 have quantum efficiencies associated therewith. This is to say that, while there may be average numbers of electrons 114 and secondary positive ions 116 generated for a particular type of ion, the exact numbers of electrons 114 and secondary positive ions 116 that are generated with each primary ion collision will vary, as will the number of electrons 118 generated as a result of a secondary positive ions 116 colliding with the grounded plate 110. As a consequence of this, the signal associated with the detection of a primary ion 112 will fall within a pulse height distribution of the ion detector 100.

For relatively high ion masses, there will be a relatively high number of secondary positive ions generated. This means that electrons 118 generated by collisions of the secondary positive ions 116 with the grounded plate 110 may make a relatively large contribution to the signal detected by the electron detector 104. This results in a relatively broad pulse height distribution of ion detector 100 for relatively high ion masses. When the pulse height distribution is broad, the number of ions entering the ion detector 100 may not be able to be reliably quantified, particularly for low numbers of ions.

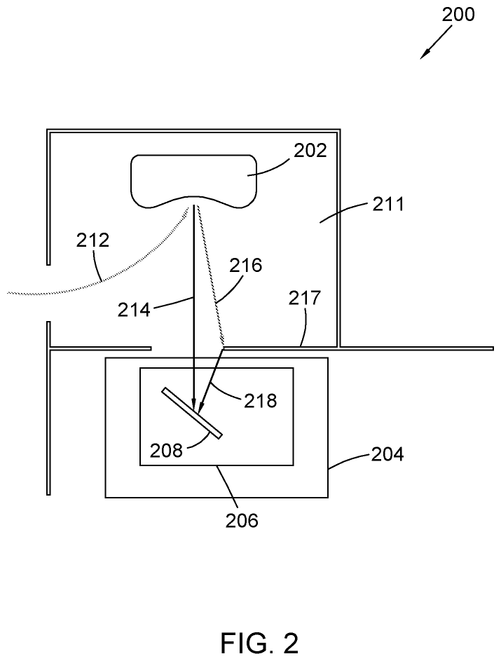

FIG. 2 shows a schematic of an alternative example of an ion detector 200, not having the features of the present invention. The ion detector 200 comprises a convex high energy dynode 202 that emits electrons 214 when negative primary ions 212 impact upon the dynode 202. The ion detector 200 also comprises an electron detector 204 comprising an electron multiplier 206. The electron multiplier 206 comprises at least a first multiplier dynode 208 and may comprise a plurality of multiplier dynodes that each amplify an electron signal by generating increasing numbers of electrons as the electrons collide on each of the multiplier dynodes. The amplified electron signal may then be detected using an appropriate circuit, as is known in the art.

A positive electric potential is applied to the dynode 202 such that negative primary ions 212 entering a chamber 211 of the detector 200 are deflected towards, and impact upon, the dynode 202. For example, the dynode 202 may have a positive electric potential of 10 kV. The collisions of negative primary ions 212 upon the dynode 202 results in electrons 214 being emitted from the dynode 202. The first multiplier dynode 208 has a higher positive electric potential applied to it than the dynode 202 so that the electrons 214 emitted from the dynode 202 are attracted towards, and impact upon, the first multiplier dynode 208. For example, the first multiplier dynode 208 may have a positive electric potential of 12 kV applied to it. The electron signal of electrons in the electron multiplier 206 is then amplified by the electron multiplier 206 and detected by the electron detector 204 to thereby indicate the detection of primary ions.

Secondary positive ions 216 may also be generated by fragmentation of the negative primary ions 212 when they impact upon the dynode 202. The secondary positive ions 216 will be repelled by dynode 202 as well as the first multiplier dynode 208. This can result in the secondary positive ions 216 colliding with a surface in the detector 200, such as grounded wall 217 of the chamber 211. When the secondary positive ions 216 impact upon the grounded wall 217 of the chamber 211, this may generate electrons 218 that are attracted by, and impact upon, the first multiplier dynode 208. As the potential difference between the grounded wall 217 of the chamber 211 and the first multiplier dynode 208 is greater than the potential difference between the dynode 202 and the first multiplier dynode 208, electrons 218 generated from the secondary positive ions 216 impacting upon the grounded wall 217 of the chamber 211 are accelerated onto the first multiplier dynode 208 with a higher energy than the electrons 214 generated at the dynode 202.

As for ion detector 100 of FIG. 1, ion detector 200 of FIG. 2 will therefore have a relatively broad pulse height distribution for ions that may generate a relatively high number of secondary positive ions. This is because of the variance in the amounts and energies of electrons 214, 218 that impact upon the first multiplier dynode 208 as a result of a primary ion 212 impacting upon dynode 202. This can result in a particularly broad pulse height distribution for ion detector 200 because the configuration of ion detector 200 typically requires high potentials to be applied to the dynode 202 and the first multiplier dynode 208, resulting in a large difference in possible energies for electrons 214 generated at the dynode 202 compared to electrons 218 generated at the grounded wall 217 of the chamber 211. Consequently, when the pulse height distribution is relatively broad, such as for relatively high ion masses, the number of primary ions 212 entering the ion detector 200 may not be able to be reliably quantified, particularly for low numbers or rates of ions entering the ion detector 200.

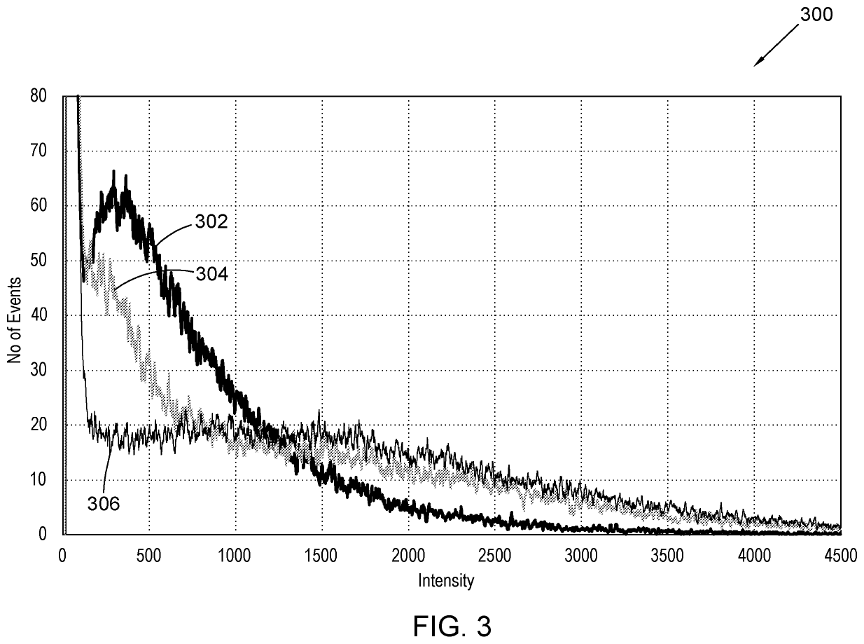

FIG. 3 shows a plot 300 of an example of pulse height distributions 302, 304, 306 for the ion detector 100 of FIG. 1. The pulse height distributions 302, 304 and 306 show the number of ion detection events as a function of the ion signal intensity detected, for different ion masses.

Pulse height distribution 302 is for primary ions having a mass of 45 Daltons. The intensities detected for pulse height distribution 302 are almost exclusively from electrons generated at the dynode 102, as relatively few secondary positive ions are generated for primary ions having the relatively low mass of 45 Daltons. The resulting shape of pulse height distribution 302 corresponds to a single mode distribution with a relatively high proportion of the detection events falling with a relatively narrow range of intensities. The shape of pulse height distribution 302 is approximately that of a Poisson distribution.

Pulse height distribution 304 is for primary ions having a mass of 733 Daltons. The shape of pulse height distribution 304 is that of a bimodal distribution having a first mode (providing a peak in the distribution) resulting from electrons generated at the dynode 102 and a second mode (providing a shoulder in the distribution) resulting from electrons generated from secondary positive ions. This results in a pulse height distribution that is neither narrow nor distinct from the noise due to a relatively large number of events having relatively high intensities compared to what would be expected for a single mode distribution provided exclusively by electrons generated at the dynode 102. The shape of pulse height distribution 304 means that the number of primary ions cannot be accurately quantified from a detected signal.

Pulse height distribution 306 is for primary ions having a mass of 2019 Daltons. On account of a high number of secondary positive ions being generated from the relatively high mass primary ions, a relatively large number of electrons generated from the secondary positive ions reach the electron detector 104 with a relatively high energy and contribute towards pulse height distribution 306. This results in the shape of pulse height distribution 306 being that of a single broad distribution that is based almost exclusively from electrons generated by the secondary positive ions.

It is accordingly seen that the pulse height distributions of ion detector 100 for relatively higher mass ions are broader, and less distinct from the noise, than those of relatively lower mass ions. This results in a reduction in the accuracy with which the relatively higher mass ions can be quantified.

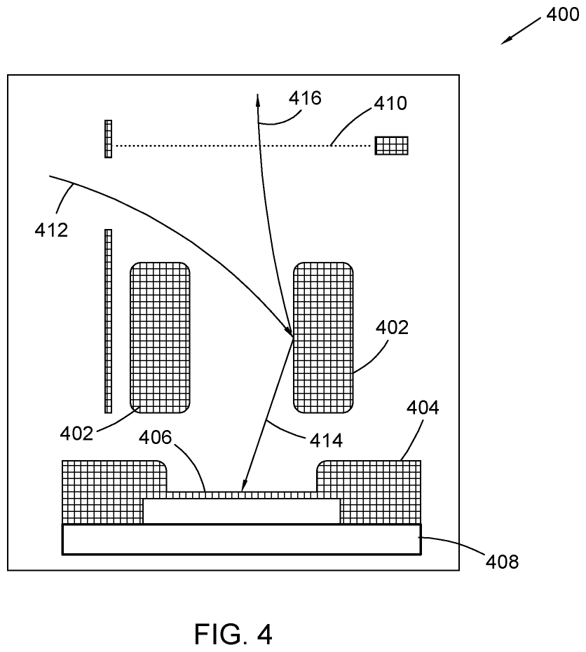

FIG. 4 shows a schematic of an ion detector 400 that is in accordance with embodiments of the present invention. The ion detector 400 comprises a dynode 402, which may be an annular dynode, and an electron detector 404. The electron detector 404 may comprise a phosphorescent screen 406 and a photomultiplier 408. However, other suitable electron detectors and/or dynode shapes may alternatively be used. Ion detector 400 may have the features of the ion detector 100 of FIG. 1, other than at least a portion of the plate electrode 110 in ion detector 100 is replaced in ion detector 400 with an electrode 410 comprising a plurality of apertures.

In ion detector 400, an electric field is defined by the dynode 402 and the apertured electrode 410 so that when negative primary ions 412 enter the ion detector 400, the field will cause the ions to impact upon the dynode 402, such as by being deflected onto the dynode 402. To define the electric field, a positive potential, such as 5 kV, may be applied to the dynode 402. The apertured electrode 410 is maintained a potential that is lower than the dynode 402. For example, the apertured electrode 410 may be maintained at a negative potential, such as −100 V, or may be grounded. The dynode 402 emits electrons 414 upon impact of the primary ions 412 on the dynode 402. Secondary positive ions 416 are also generated via fragmentation of the primary ions 412 when they impact upon the dynode 402.

A potential is applied to the electron detector 404 (e.g. to the phosphorescent screen 406) that is greater than the potential applied to the dynode 402, so that electrons 414 emitted from the dynode 402 are attracted towards, and impact upon, the electron detector 404 (e.g. at the phosphorescent screen 406). For example, the phosphorescent screen 406 may be maintained at a potential of 10 kV. When electrons 414 impact upon the phosphorescent screen 406, photons (not shown) are generated that are detected using the photomultiplier 408 in a manner known in the art. This thereby allows the detection of negative primary ions 412 that enter the ion detector 400.

Secondary positive ions 416 generated upon the primary ions 412 impacting the dynode 402 are repelled by the dynode 402 towards the apertured electrode 410. As the apertured electrode 410 comprises a plurality of apertures, at least some of the secondary positive ions 416 pass through the apertures in the apertured electrode 410 without impacting upon the apertured electrode 410. This may allow substantially all the secondary positive ions 416 to pass through the apertures of the apertured electrode 410 without striking it and generating electrons that would then be deflected onto the phosphorescent screen 406. After passing through the apertures of the apertured electrode 410, the secondary positive ions 416 may then be removed from the ion detector 400 or neutralised in any suitable manner.

Electrons may be generated when the secondary positive ions 416 collide with surfaces of the ion detector 400 after passing through the apertures of the apertured electrode 410. However, the apertured electrode 410 can prevent these electrons from reaching the electron detector 404 (e.g. at the phosphorescent screen 406). For example, if a negative potential is applied to the apertured electrode 410 then electrons generated by the secondary positive ions 416 striking a surface will be repelled by the apertured electrode 410 such that they are prevented from passing through the apertures of the apertured electrode 410 and are thereby prevented from impacting upon the electron detector 404. Alternatively, the apertured electrode 410 may be grounded so as to prevent electrons generated on the other side of the apertured electrode 410 to the electron detector 404 from being attracted to the electron detector 404. Electrons generated from the secondary positive ions 416 that have passed through the apertures of the apertured electrode 410 may be dissipated in the ion detector 400 on the other side of the electrode 410 to the electron detector 404, e.g. by being attracted to a positive electrode and being neutralised.

The use of apertured electrode 410 in the ion detector 400 therefore reduces the number of, or eliminates, electrons that have been generated from secondary positive ions 416 from reaching the electron detector 404. As such, a greater proportion of the electrons that impact on the electron detector 404, such as substantially all of these electrons, are derived from the electrons that are directly generated when the primary ions 412 impact the dynode 402. This can be irrespective of the mass of the negative primary ion. This can result in pulse height distributions of the ion detector 400 for ions of all masses having a narrower width and/or greater signal to noise ratio compared to an ion detector that does not employ an apertured electrode 400 in the manner disclosed herein, such as compared to the ion detector 100 of FIG. 1.

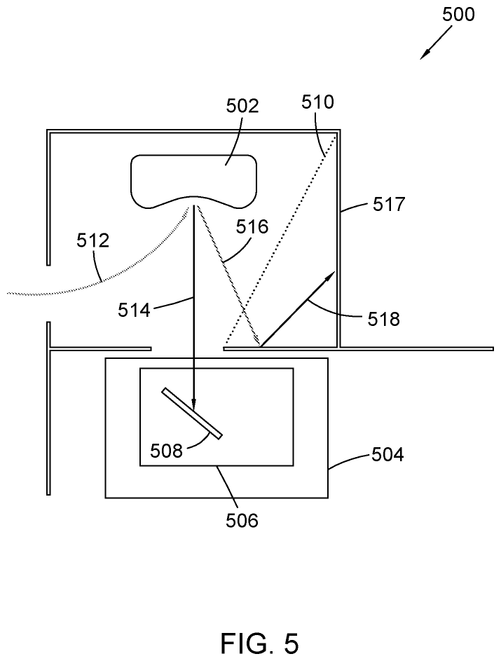

FIG. 5 shows a schematic of an ion detector 500 that is in accordance with alternative embodiments of the present disclosure to the ion detector 400 of FIG. 4. Ion detector 500 comprises a dynode 502, which may be a convex dynode. The dynode 502 may have a positive electrical potential of, for example, 10 kV applied to it. It is possible to use alternative dynode shapes and/or potentials. Ion detector 500 also comprises an electron detector 504. The electron detector 504 may comprise an electron multiplier 506 having at least a first multiplier dynode 508. The electron detector 504 may comprise a chain of electron multiplier dynodes for sequentially amplifying the electron current. Other suitable electron detectors may also be used, such as the electron detector 404 of the ion detector 400 shown in FIG. 4. Ion detector 500 may have the features of ion detector 200 of FIG. 2, other than ion detector 500 comprises an electrode 510 comprising a plurality of apertures, as described further below

Negative primary ions 512 that enter the detector chamber 511 are attracted to, and impact upon, the dynode 502. When the negative primary ions 512 impact upon the dynode 502, electrons 514 are emitted from the dynode 502 and secondary positive ions 516 are also generated via fragmentation of the negative primary ions 512. The electrons 514 emitted from the dynode 502 are attracted towards, and impact upon, the electron detector 504, such as at the first multiplier dynode 508. To achieve this, the electron detector 504 (e.g. the first multiplier dynode 508) has a higher electric potential applied to it than the dynode 502. For example, a potential difference between the dynode 502 and the first multiplier dynode 508 may be from 1 to 5 kV. For instance, the dynode 502 may be at a potential of 10 kV and the first multiplier dynode 508 may be at a potential of 12 kV. The electron signal inside the electron multiplier 506 may be amplified by the first multiplier dynode 508 emitting electrons when impacted by electrons emitted from the dynode 502. The resulting electron signal of electrons in the electron multiplier 506 may be further amplified by additional multiplier dynodes within the electron multiplier 506. The amplified electron signal generated by the electron multiplier 506 can be measured by an appropriate circuit in the known manner and used by the ion detector 500 to thereby indicate the detection of primary ions 512 entering the ion detector 500.

The dynode 502 repels secondary positive ions 516 generated when the negative ions impact upon the dynode 502. The secondary positive ions 516 may also be deflected by a repulsive force from the electron detector 504 (e.g. from the first multiplier dynode 508). The ion detector 500 comprises an apertured electrode 510 and a potential difference is arranged between the apertured electrode 510 and the dynode 502 (and the apertured electrode 510 and the first multiplier dynode 508) so as to result in the secondary positive ions 516 being transmitted towards the apertured electrode 510. For example, the apertured electrode 510 may be maintained at a potential that is more negative than the dynode 502. For instance, the apertured electrode 510 may be grounded or may have a negative potential, such as −100 V, applied to it. As the apertured electrode 510 comprises a plurality of apertures, at least some of the secondary positive ions 516 pass through the apertures without impacting upon the apertured electrode 510 and hence without generating electrons that would then be attracted onto the electron detector 504 (e.g. onto the first multiplier dynode 508). After passing through the apertures of the apertured electrode 510, the secondary positive ions 512 may then be removed from the ion detector 500 or neutralised in any suitable manner, such as described above in relation to FIG. 4. Alternatively, the secondary positive ions 512 may strike a surface downstream of the apertured electrode 510 (i.e. on the other side of the apertured electrode 510 to the dynode 502) and generate electrons 518, but these electrons 518 are prevented from reaching the electron detector 504 in any suitable manner, such as described above in relation to FIG. 4.

For example, as depicted in FIG. 5, the apertured electrode 510 may be provided between the dynode 502 and one or more walls 517 of the detector chamber. The secondary positive ions 516 may pass through the apertured electrode 510 and collide with a wall 517 of the chamber and electrons 518 may be generated. The apertured electrode 510 may prevent electrons 518 from being attracted into the electron detector 504. For example, if the apertured electrode 510 has a negative potential applied to it then electrons 518 will be repelled by the apertured electrode 510. Alternatively, if the apertured electrode 510 is grounded then this can also prevent the electrons from being attracted into the electron detector 504 by shielding the electrons 518 from the attractive potential of the electron detector 504.

The use of apertured electrode 510 in the ion detector 500 therefore reduces the number of, or eliminates, electrons that have been generated from secondary positive ions 516 from reaching the electron detector 504. As such, a greater proportion of the electrons that impact on the electron detector 504, such as substantially all of these electrons, are derived from the electrons that are directly generated when the primary ions 512 impact the dynode 502. This can be irrespective of the mass of the negative primary ion. This can result in pulse height distributions of the ion detector 500 for ions of all masses having a narrower width and/or greater signal to noise ratio compared to an ion detector that does not employ an apertured electrode 510 in the manner disclosed herein, such as compared to the ion detector 200 of FIG. 2.

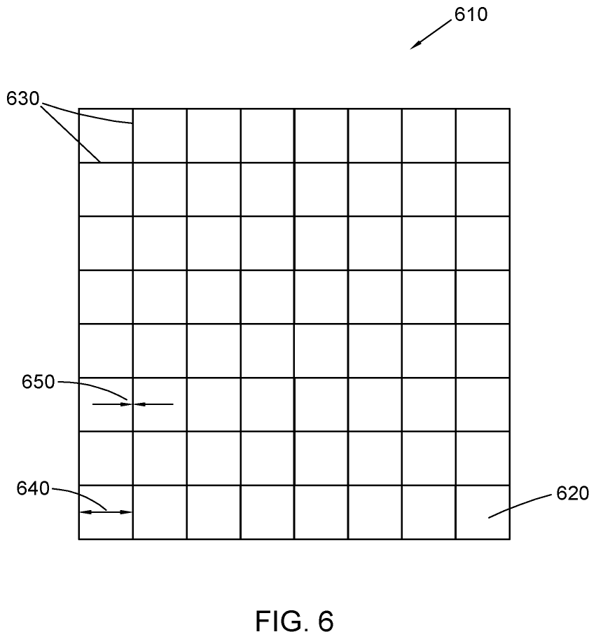

FIG. 6 shows a schematic of an apertured electrode 610 that may be used in the embodiments described herein. Both the electrode 410 of embodiments described in relation to FIG. 4 and the electrode 510 of embodiments described in relation to FIG. 5 may each correspond to the apertured electrode 610. The apertured electrode 610 may (or may not) comprise a plurality of apertures 620 arranged in a two-dimensional array. The apertures 620 may all be square shaped as shown in FIG. 6. However, other shapes may be used for some or all of the plurality of apertures 620. For example, the plurality of apertures 620 may comprise elongated rectangular, circular, oval, triangular, hexagonal or slotted apertures. A mix of different shaped apertures may be used or the apertures may all be substantially the same shape.

The apertured electrode 610 may be a grid or a mesh. The apertures may be square and separated from one another by sidewalls 630 of the electrode 610. The apertures 620 each have a width 640 and the distance 650 between adjacent apertures 620 is the width of the sidewalls 630. The width 640 of the apertures 620 may be between 1 and 10 mm, such as between 2 and 5 mm, or between 3 and 4 mm. The ratio of the width 640 of the aperture 620 to the distance 650 separating adjacent apertures 620 may be set so that the apertures 620 are as large as possible so as to transmit the secondary ions while still allowing the electrode 610 to define a suitably uniform electrical potential across the faces of the electrode 610. For instance, the ratio of the average width 640 of each aperture 620 to the average distance 650 separating adjacent apertures 620 may be between 5 and 20, such as between 8 and 12 or between 9 and 11. Having a relatively uniform potential across the faces of the electrode 610 can reduce the likelihood that secondary positive ions will be deflected towards the electrode 610 and collide with it, and/or will allow a suitable field to be defined by the electrode 610 and a dynode so that negative primary ions will be reliably deflected towards, and impact upon, the dynode.

As described above, the apertures need not be square and may be other shapes. As such, the proportion of the apertured electrode 610 that is formed from the apertures may be defined by the void fraction, rather than by various widths. The void fraction may be defined as the combined area of the apertures divided by the total area of the apertured electrode (i.e. including the apertures and electrode material between the apertures). A relatively large void fraction for the electrode 610 reduces the likelihood that secondary positive ions will collide with the electrode 610. For example, a void fraction of the electrode 610 may be ≥0.5; ≥0.6; ≥0.7; ≥0.8; ≥0.9; or ≥0.95.

It will be appreciated that embodiments described herein allow for a reduction in the width and/or increase in signal to noise ratio of the pulse height distribution of an ion detector for a mass and/or ion mobility spectrometer. This can be achieved by using an electron detector to detect electrons from primary ions impacting a dynode while transmitting secondary ions generated at the dynode through an apertured electrode.

Although the present disclosure has been described with reference to various embodiments, it will be understood by those skilled in the art that various changes in form and detail may be made without departing from the scope defined by the accompanying claims.

For example, although the embodiments described herein refer to primary ions to be detected impacting upon a dynode, plural dynodes may be provided for primary ions to impact upon. For example, there may be one dynode intended for negative primary ions to impact upon and one dynode intended for positive primary ions to impact upon. The techniques described herein may be used for the dynode used to detect negative primary ions.

Although the embodiments of the present disclosure refer to the generation of secondary positive ions it will be appreciated that secondary negative ions may also be generated via fragmentation. However, secondary negative ions may be less likely to be deflected to impact upon components having lower electric potentials than the dynode. Secondary negative ions may therefore be less likely to generate electrons that are accelerated towards the electron detector under a larger potential difference than the potential difference between the dynode and the electron detector.

Although the embodiments of the present disclosure refer to the removal of secondary positive ions away from the electron detector, it will be appreciated that some proportion of secondary positive ions may impact upon components and generate electrons that are detected by the electron detector. However, an ion detector with an apertured electrode as described herein may at least reduce the number of electrons generated from secondary positive ions that are detected by the electron detector.

Although embodiments of the apertured electrode have been described as mesh or grid electrodes (e.g. such as formed from woven or overlaid wires), it is contemplated that the apertured electrode may instead be formed from apertured sheet or plate material, such as sheet metal having apertures therein.

Although the embodiments of the present disclosure refer to the primary ions being negative ions, the invention may less preferably be implemented for positive primary ions.

The invention claimed is:

1. An ion detector for a mass and/or ion mobility spectrometer, comprising:
a dynode arranged and configured such that primary ions to be detected by the ion detector impact upon the dynode and generate first electrons and secondary positive ions;
an electron detector arranged and configured to attract and detect said first electrons; and
an apertured electrode, comprising a plurality of apertures, that is arranged and configured such that at least some of said secondary positive ions pass through the apertures of the electrode.

2. An ion detector as claimed in claim 1, wherein the apertured electrode is arranged and configured within the ion detector such that at least some of said secondary positive ions pass through said apertures and then strike a surface of the ion detector that is on the opposite side of the apertured electrode to said dynode.

3. An ion detector as claimed in claim 2, configured such that when said secondary positive ions strike said surface they generate second electrons, and wherein the apertured electrode is arranged within the ion detector and configured such that said second electrons are unable to reach the electron detector.

4. An ion detector as claimed in claim 3, wherein the ion detector is configured to provide an electric field between the dynode and the electron detector that attracts the first electrons from the dynode to the electron detector, and wherein the apertured electrode is configured to prevent the electric field between the dynode and the electron detector from attracting the second electrons towards the electron detector.

5. An ion detector as claimed in claim 4, wherein the ion detector is configured to provide the electric field between the dynode and the apertured electrode by the ion detector applying a more negative electric potential to the apertured electrode than is applied to the dynode.

6. An ion detector as claimed in claim 4, wherein the ion detector is configured to maintain the apertured electrode at ground potential or at a negative potential.

7. An ion detector as claimed in claim 1, wherein at least some of the apertures in the apertured electrode each have a shape selected from the following shapes: a square; an elongated rectangle, a circle, an oval, a triangle, a polygon, a hexagon, or a slot.

8. An ion detector as claimed in claim 1, wherein the apertures in the apertured electrode are square and a ratio of the average width of the apertures to the average distance separating adjacent ones of the apertures is between 5 and 15, between 6 and 14, between 7 and 13, between 8 and 12, or between 9 and 11.

9. An ion detector as claimed in claim 1, wherein the combined area of the apertures of the apertured electrode divided by the total area of the apertured electrode is: ≥0.5; ≥0.6; ≥0.7; ≥0.8; ≥0.9; or ≥0.95.

10. An ion detector as claimed in claim 1, wherein the plurality of apertures comprises at least 10 apertures, optionally at least 50 apertures.

11. An ion detector as claimed in claim 1, wherein the average width of the apertures is between 1 and 10 mm, optionally between 2 and 5 mm.

12. An ion detector as claimed in claim 1, wherein the plurality of apertures are arranged in a two-dimensional array, optionally wherein the electrode is provided as a grid or a mesh.

13. An ion detector as claimed in claim 1, wherein the ion detector is arranged and configured to provide an electric field between the apertured electrode and the dynode to deflect primary ions away from the apertured electrode and towards the dynode such that the primary ions impact upon the dynode.

14. An ion detector as claimed in claim 1, wherein the apertured electrode forms part of a wall of a chamber of the ion detector containing the dynode.

15. A mass and/or ion mobility spectrometer comprising the ion detector of claim 1.

16. A method of detecting ions for mass and/or ion mobility spectrometry, the method comprising:
providing an ion detector comprising a dynode, an electron detector and an apertured electrode comprising a plurality of apertures;
impacting primary ions to be detected upon the dynode to generate first electrons and secondary positive ions;
attracting the first electrons to the electron detector and detecting the first electrons using the electron detector; and
passing at least some of said secondary positive ions through the apertures of the apertured electrode.
